(19) United States
(12) Patent Application Publication
(10) Pub. No.: US 2025/0030242 A1
(43) Pub. Date: Jan. 23, 2025

(54) Grid Direct-current Flexible Loop Closing Control Device and Method

(71) Applicants: NANJING HEXI ELECTRIC CO., LTD., Nanjing (CN); XIJING SMART ENERGY TECHNOLOGY (NANJING) CO., LTD., Nanjing (CN); JIANGSU QIANHAI ZHIYUAN TECHNOLOGY CO., LTD., Nanjing (CN)

(72) Inventors: Xiaohui HUANG, Nanjing (CN); Chengxi LIU, Nanjing (CN); Weiling GU, Nanjing (CN); Wei LI, Nanjing (CN); Zhiguo LI, Nanjing (CN)

(73) Assignees: NANJING HEXI ELECTRIC CO., LTD., Nanjing (CN); XIJING SMART ENERGY TECHNOLOGY (NANJING) CO., LTD., Nanjing (CN); JIANGSU QIANHAI ZHIYUAN TECHNOLOGY CO., LTD., Nanjing (CN)

(21) Appl. No.: 18/714,099

(22) PCT Filed: Nov. 8, 2022
(86) PCT No.: PCT/CN2022/130538

§ 371 Date: May 29, 2024

(30) Foreign Application Priority Data
Nov. 29, 2021 (CN) 202111429669.9

(51) Int. Cl. H02J 3/06; H02J 1/08; H02J 3/38; H02J 7/34; H02J 13/00

(52) U.S. Cl. CPC H02J 3/06; H02J 1/084; H02J 3/38; H02J 7/34; H02J 13/00002; H02J 13/00006; H02J 2203/20; H02J 2300/24; H02J 2300/28

(57) ABSTRACT

A grid direct-current flexible loop closing control device is a series-parallel device and includes a series coupling unit, a parallel coupling unit, a bypass switch circuit, and a loop closing main controller. The series-parallel devices is connected in series between each distribution line and a load, and after a loop closing instruction is received, the loop closing control devices are set to work in a voltage control mode; after direct-current bus voltages of two loop closing control devices are identical, a system enters a loop closing state. Before exiting loop closing, the loop closing control devices are set to be in a PQ control mode, access switches are sequentially turned off after P and Q are gradually decreased to zero, and a loop closing process is ended. The device is simple in structure, low in cost and high in efficiency, and has fewer loop-closing monitoring quantities.

### CROSS REFERENCE TO THE RELATED APPLICATIONS

This application is the national phase entry of International Application No. PCT/CN2022/130538, filed on Nov. 8, 2022, which is based upon and claims priority to Chinese Patent Application No. 202111429669.9, filed on Nov. 29, 2021, the entire contents of which are incorporated herein by reference.

### TECHNICAL FIELD

The invention belongs to the technical field of control for optimal operation of distribution networks, and particularly relates to a grid direct-current flexible loop closing control device and method.

### BACKGROUND

Existing distribution systems face the problems of insufficient power supply capacity, difficulty in guaranteeing power quality, and low power supply reliability. To optimize the network structure, traditional distribution networks adopt sectionalizing switches and tie switches to realize loop closing, but this cannot realize flexible power mutual aid, and the voltage difference and phase difference at the loop closing point may lead to a large impact current, affecting safe and stable operation of a power grid. At present, there have already been related research and trial projects for improving power supply reliability, such as petal-shaped distribution networks, cellular distribution networks, multiport direct-current flexible loop closing, and other power distribution techniques. For example, the power supply mode of non-transregional petal-shaped distribution networks is characterized by simple structure, flexible load transfer, short fault insolation time, high reliability and good expandability. However, such a power supply mode has the following problems: the use of a single power supply for loop closing can improve the reliability as compared with open-loop operation, but it cannot guarantee reliable power supply in case of a superior grid fault. In case of a fault, the load on a whole loop is transferred to a feeder, so a redundancy design of a feeder cable is needed.

The large-scale access of renewable energy, the diversified growth of electrical loads and the increase of the proportion of direct-current loads pose a great challenge to the structural form and operation mode of traditional distribution networks. With the development of power electronic devices, professionals at home and abroad put forward the concept of flexible interconnection equipment, such as smart soft switches (flexible multi-state switches), unified power flow controllers and ring power equalizers, which realize flexible interconnection of distribution networks by means of the rapid and efficient control capacity of power electronic devices, achieve flexible control and power mutual aid of distribution networks with different voltage frequencies, amplitudes and phases, promote new energy consumption, and satisfy the requirement for high-quality power supply, thus improving the reliability, flexibility and controllability of the distribution networks. There are generally two types of flexible interconnection devices: alternating-current loop closing devices based on power electronic equipment, and direct-current loop closing devices, wherein the alternating-current loop closing devices typically adopt back-to-back bidirectional converters, have a powerful power flow control capacity and can realize flexible interconnection of transregional distribution networks, but such loop closing devices also have the disadvantages of excessively large equipment capacity and size and high cost, and compared with the direct-current loop closing devices, the phase-angle loop closing condition needs to be taken into account, and operation is time-consuming. As for the direct-current loop closing devices, a power transfer system generally adopts an alternating-current and direct-current hybrid power supply mode, and direct-current buses in different regions are used for loop closing. As compared with alternating-current loop closing, direct-current loop closing avoids phase angle detection, adopts converters to control the direct-current voltage to satisfy the loop closing condition quickly, and has higher loop closing efficiency, thus being more suitable for loop closing in an area with a large number of direct-current loads and a new energy area. The use of multiport direct-current loop closing facilitates energy storage and local access of direct-current loads, flexibly changes the power supply mode of distribution networks, improves the new energy consumption level, and is more advantageous in regulating ability and operation reliability due to the mutual support formed by multiple feeders. In case of a fault, rapid and seamless switching of the operation mode of multiple groups of converters can be realized, thus guaranteeing rapid transfer of important loads. However, existing flexible interconnection devices adopt back-to-back/multiport power electronic converters, thus having the problems of excessively large equipment capacity and size and operation loss and excessively high operation and maintenance cost. It thus can be seen that such flexible loop closing devices have a low equipment utilization rate and a high comprehensive cost, which greatly limit the application and promotion of the flexible loop closing devices.

Therefore, a flexible loop closing control device with a simple structure, higher efficiency and a lower cost and a flexible loop closing control method are needed to realize transregional flexible interconnection and power mutual aid of distribution networks to improve power supply reliability.

### SUMMARY

To solve the above problems, the invention provides a grid direct-current flexible loop closing control device, wherein the direct-current flexible loop closing control device is a series-parallel device, includes two alternating-current ports and a direct-current port, and further includes a three-port series coupling unit, a two-port parallel coupling unit, a bypass switch and a direct-current loop closing main controller;
wherein, two alternating-current ports of the three-port series coupling unit are connected in series to a line, and a direct-current port of the three-port series coupling unit is connected to a direct-current side of the parallel coupling unit;
an alternating-current side of the two-port parallel coupling unit is connected in parallel to a distribution network line, and a direct-current port of the two-port parallel coupling unit is connected to a direct-current side of the series coupling unit to form a direct-current output port of the series-parallel device;
the bypass switch is connected in parallel to the two alternating-current ports of the series coupling unit, and the direct-current loop closing main controller is used for logic control of loop closing and receiving remote control.

The direct-current flexible loop closing control device can realize loop closing on the direct-current side, not only can realize flexible power transfer between distribution networks and quick exit in case of a fault, but also can improve the power supply reliability of the distribution networks to be over 99.99% and realize load balance of a line in a heavy-load transformer region and a light-load transformer region, thus guaranteeing power supply quality; and only the amplitude of the direct-current voltage needs to be monitored for loop closing, and the phase angle of the loop closing voltage does not need to be monitored as compared with alternating-current loop closing, thus improving the economy, safety and efficiency of power supply of distribution networks in the transformer regions.

Preferably, the series coupling unit includes a series coupling transformer and a power-bidirectionally controllable inverter, wherein a primary side of the series coupling transformer is connected to an alternating-current line, and a secondary side of the series coupling transformer is connected to an alternating-current side of the inverter. The parallel coupling unit includes a power-bidirectionally controllable inverter, wherein an alternating-current side of the inverter is connected in parallel to an alternating-current distribution network line, and a direct-current side of the inverter is connected to the direct-current side of the series coupling unit, thus forming a basic topology of the series-parallel loop closing control device is formed.

Preferably, direct-current loop closing is implemented by connecting the flexible loop closing control device in series between a line in each transformer region requiring loop closing and a load, and then connecting the direct-current ports of the flexible loop closing control devices in the transformer regions requiring loop closing to transfer an active power flow between the transformer regions requiring loop closing by means of the direct-current ports.

Preferably, to simplify the topology of the series-parallel loop closing control device to further reduce the manufacturing cost, the flexible loop closing control device is connected in series between the line in each transformer region requiring loop closing and the load, wherein the flexible loop closing control device in one transformer region only reserves the series coupling unit, the direct-current port of which is connected to a direct-current bus of the series-parallel loop closing control device in the other transformer region to realize flexible loop closing of the two transformer regions. Because the parallel coupling unit in one transformer region is omitted, the cost can be reduced while flexible loop closing is realized.

Preferably, to improve power supply flexibility and active power flow supportability to relieve a pressure in power supply capacity, an energy storage device with a DC/DC converter is connected to the direct-current bus of the series-parallel loop closing control device, and the control flexibility of power supply in the transformer regions is further improved by means of a flexible charge-discharge ability of the energy storage device. Moreover, the topology is beneficial for improving a new energy accepting ability, realizing continuous and combined supply of new energy and stored energy, and achieving power supply to direct-current loads.

Th solve the above problems, the invention also provides a grid direct-current flexible loop closing control method, including the following steps:
Step 1, establishing a grid direct-current flexible loop closing control device system model, monitoring for a long time power of two transmission lines requiring loop closing, and making preparation in real time for loop closing;
Step 2, before loop closing, setting a bus tie switch and an access switch to be in an off state and two loop closing control devices to be in a voltage control mode;
Step 3, after a loop closing instruction is received, determining whether direct-current bus voltages of the two loop closing control devices are identical; if not, regulating the direct-current bus voltages by means of a constant direct-current voltage control mode of parallel coupling units; after the direct-current bus voltages of the two loop closing control devices are determined as identical, turning on the direct-current access switch K to allow a system to enter a loop closing state; after loop closing, dynamically adjusting an amplitude and phase of an additional voltage of a series coupling transformer to realize flexible power mutual aid of two transformer regions subjected to loop closing; and
Step 4, before exiting loop closing, setting the two flexible loop closing control devices to work in a PQ control mode, and turning off the access switch K after P and Q of the two flexible loop closing control devices are gradually decreased to zero, such that a direct-current flexible loop closing process is ended.

Preferably, the grid direct-current flexible loop closing control device system model is established in Step 1, wherein the grid direct-current flexible loop closing control device system model includes two series-parallel devices and an access switch, each of the series-parallel devices is connected in series between a transmission line and a load, and direct-current ports of the two flexible loop closing control devices are connected to realize direct-current loop closing; and each of the series-parallel devices includes a three-port series coupling unit, a two-port parallel coupling unit, a bypass switch and a direct-current loop closing main controller; two alternating-current ports of the three-port series coupling unit are connected in series to the line, and a direct-current port of the three-port series coupling unit is connected to a direct-current side of the parallel coupling unit;
an alternating-current side of the two-port parallel coupling unit is connected in parallel to a distribution network line, and a direct-current port of the two-port parallel coupling unit is connected to a direct-current side of the series coupling unit to form a direct-current output port of the series-parallel device;
the bypass switch is connected in parallel to the two alternating-current ports of the series coupling unit.

Preferably, to improve power supply flexibility and active power flow supportability, an energy storage device is connected to a direct-current bus of the series-parallel device, and the control flexibility of power supply in the transformer regions is further improved by means of a flexible charge-discharge ability of the energy storage device; moreover, the direct-current bus of the series-parallel device is connected to a direct-current distribution network with photovoltaic, wind or direct-current loads to improve a new energy consumption level of the system and flexibly change a power supply mode of the distribution network.

Preferably, to satisfy economic construction requirements, the grid direct-current flexible loop closing control device system model is improved as follows: the grid direct-current flexible loop closing control device system model includes the series-parallel device, a series coupling device and an access switch; the series coupling device is formed merely by the series coupling module in the series-parallel device, thus reducing a manufacturing cost; similarly, the series-parallel device and the series coupling device are connected in series between the distribution lines requiring loop closing and the load, and direct-current ports of the series-parallel device and the series coupling device are connected to realize direct-current loop closing.

Preferably, in Step 2, two loop closing control devices are set to be in the voltage control mode, wherein constant direct-current voltage control is performed by means of the parallel coupling units of the two loop closing control devices, and direct-current closing is realized when the direct-current bus voltages of the loop closing control devices in the two transformer regions are identical.

Preferably, in Step 3, the direct-current bus voltages are regulated by means of the constant direct-current voltage control mode of parallel coupling units, wherein a direct-current side voltage of a parallel device is detected and compared with a given direct-current voltage, and an obtained voltage difference is input to a PI controller, and a PWM voltage control signal of a parallel transformer is output after current inner loop control; wherein, the PI controller or other controllers are used.

Preferably, in Step 3, the amplitude and phase of the additional voltage of the series coupling transformer is dynamically adjusted to realize flexible power mutual aid of the two transformer regions subjected to loop closing, wherein an output voltage of the series coupling transformer in the transformer region where power needs to be fed is regulated, and an amplitude and phase angle of the output voltage are regulated within ranges to change active power and reactive power of the line to which power will be fed, thus realizing flexible regulation of active power and reactive power transmitted between the two transmission lines.

Preferably, during flexible regulation of the active power and reactive power transmitted between the two transmission lines, active power control is characterized in that the amplitude and phase angle of the additional voltage of the series coupling transformer are controlled by a voltage loop of the series coupling unit to realize active flow power control, and specifically includes the following steps:
(1) acquiring, by a phase-locked loop (PLL), a voltage phase of a power supply bus connected to a series device;
(2) acquiring an alternating-current voltage U of a supply side of a series-side inverter, performing dq conversion by means of the voltage phase of the alternating-current bus to obtain U_{d} and U_{q}, comparing the alternating-current voltage with a given voltage reference value, inputting an obtained voltage difference into a PI controller to obtain an output current reference value, wherein the PI controller or other controllers are used; and
(3) subjecting the current reference value to current inner loop control to output a voltage control signal to a PWM series-side transformer, such that the amplitude and phase angle of the additional voltage ΔV of the series coupling transformer are controlled.

Preferably, during flexible regulation of the active power and reactive power transmitted between the two transmission lines, reactive power control is characterized in that the parallel coupling unit is used to realize reactive flow power control by means of closed-loop control, and specifically includes the following steps:
(1) acquiring, by a PLL, a voltage phase of an alternating-current bus connected to the parallel device; and
(2) acquiring a reactive current of an alternating-current system connected to an inverter of the parallel coupling unit, performing dq conversion to obtain a current instruction, and inputting a current difference between the reactive current and a given value to a PI controller to output a PWM voltage control signal to allow a parallel converter to output reactive power required by the system, such that reactive compensation is realized, wherein the PI controller or other controllers are used.

The invention has the following advantages:

(1) The grid direct-current flexible loop closing control device and method provided by the invention can realize online loop closing and avoid load transfer after a power failure, thus improving power supply reliability;

(2) The grid direct-current flexible loop closing control device provided by the invention has a simple structure, the design capacity of the converter in the series-parallel device is low, and compared with traditional back-to-back loop closing devices, the manufacturing cost is lower.

(3) Loop closing in the invention is an alternating-current and direct-current hybrid power supply mode, dynamic reconfiguration of distribution networks in an extreme condition and continuous and combined supply of new energy and stored energy can be realized, and flexible power supply can be provided for direct-current loads.

(4) In the invention, the real-time power of transformer regions requiring loop closing is monitored, and a loop closing instruction is received in real time. Flexible loop closing or exit can be realized by controlling the amplitude of direct-current bus voltages of two lines, thus ensuring efficient and stable loop closing.

(5) The loop closing control device in the invention adopts a power electronic converter as a main loop closing control part, and a high response speed and high control accuracy can be realized by controlling a switch to act quickly, and compared with traditional closed-loop operation based on a tie switch, mechanical abrasion is small, and the service life of the device is long.

(6) In the invention, loop closing is performed by the direct-current side of two devices, and in case of a fault, the devices can be bypassed to a bypass state to guarantee normal operation of an original power supply line, so the reliability is high.

(7) According to the direct-current closing method in the invention, the loop closing condition can be met as long as the voltage amplitudes of the direct-current sides are equal, and control of the amplitude and phase angle of alternating-current voltages during alternating-current loop closing is avoided, so the loop closing efficiency is higher.

### BRIEF DESCRIPTION OF THE DRAWINGS

FIG. 1 illustrates a structural diagram of an implementation of a grid direct-current flexible loop closing control device according to the invention;

FIG. 2 illustrates a structural diagram of the grid direct-current flexible loop closing control device having a direct-current distribution network accessed thereto according to the invention;

FIG. 3 is a structural diagram of an implementation of an improved grid direct-current flexible loop closing control device according to the invention;

FIG. 4 is a flow diagram of a control method for realizing grid direct-current flexible loop closing control according to the invention;

FIG. 5 illustrates the structural diagram of an implementation of a three-port series coupling unit of the direct-current flexible loop closing control device according to the invention;

FIG. 6 is a structural diagram of an implementation of a two-port parallel coupling unit of the direct-current flexible loop closing control device according to the invention;

FIG. 7 illustrates a vector diagram of a voltage outer loop control strategy for realizing direct-current voltage control according to the invention;

FIG. 8 illustrates a vector diagram of a current inner loop control strategy for realizing direct-current voltage control according to the invention;

FIG. 9 illustrates a simplified system diagram and vector diagram when the direct-current flexible loop closing control device is used for direct-current flexible loop closing control of a power grid according to the invention;

FIG. 10 illustrates a block diagram of a vector control strategy for realizing flexible loop closing control of a power grid according to the invention.

### DETAILED DESCRIPTION OF THE EMBODIMENTS

The technical solution of the invention is further described specifically below in conjunction with the accompanying drawings.

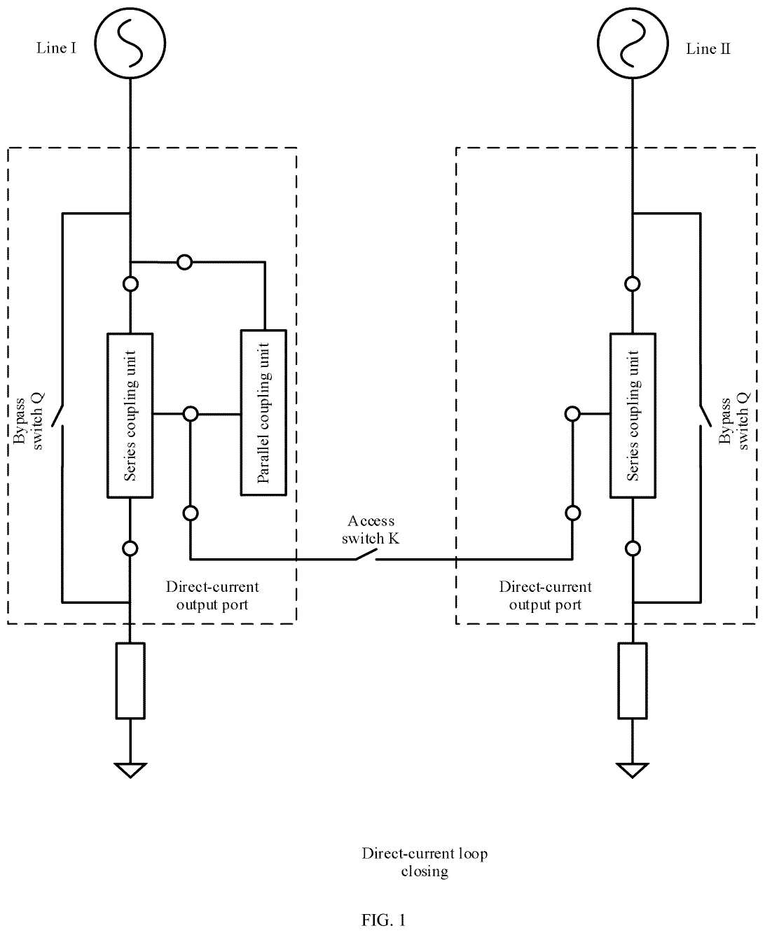

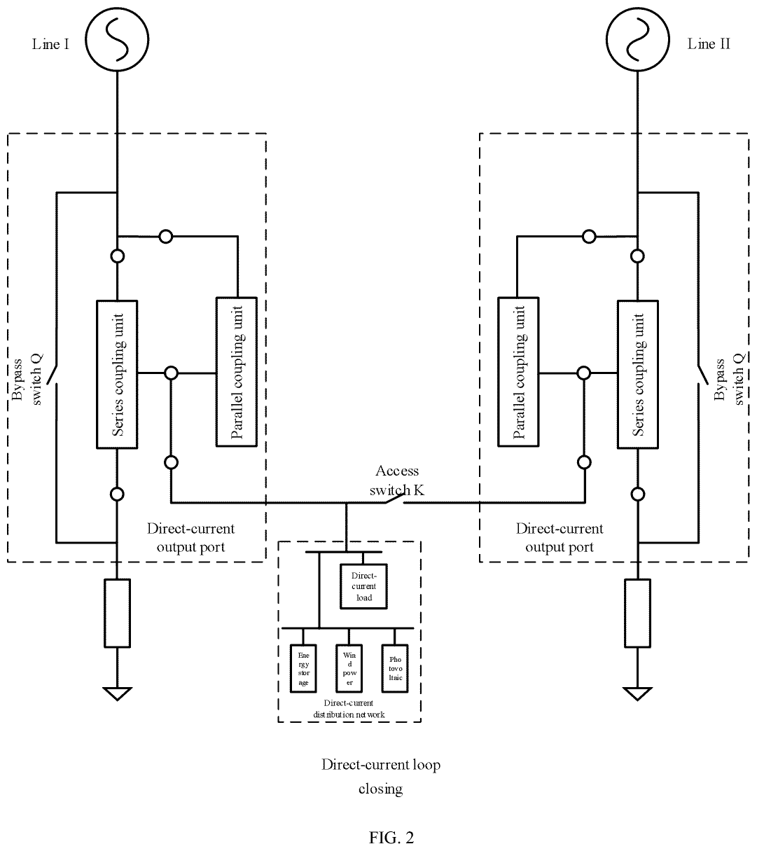

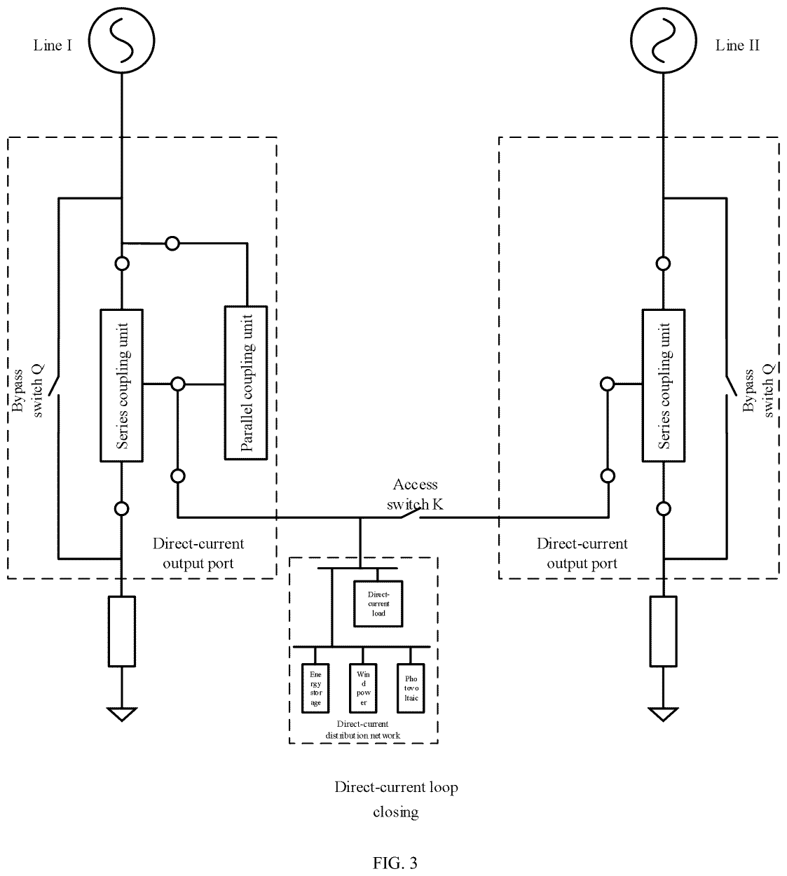

Step 1, a grid direct-current flexible loop closing control device system model is established, as shown in FIG. 1. In this implementation, the grid direct-current flexible loop closing control device system model includes two series-parallel devices and an access switch. Each series-parallel device is connected in series between a distribution line and a load, and direct-current ports of flexible loop closing control devices in transformer region requiring loop closing are connected to realize direct-current loop closing. Each series-parallel device has two alternating-current output ports and a direct-current output port, and includes a series coupling unit, a parallel coupling unit, a bypass switch and a direct-current loop closing main controller; two alternating-current ports of the three-port series coupling unit are connected in series to a line, and a direct-current port of the three-port series coupling unit is connected to a direct-current side of the parallel coupling unit; an alternating-current side of the two-port parallel coupling unit is connected in parallel to a distribution network line, and a direct-current port of the two-port parallel coupling unit is connected to a direct-current side of the series coupling unit to form a direct-current output port of the series-parallel device; in addition, the bypass switch is connected in parallel to the two alternating-current ports of the three-port series coupling unit, as shown in FIG. 1. Further, to improve power supply flexibility and active power flow supportability, an energy storage device is connected to a direct-current bus of the device, and the control flexibility of power supply of the transformer region is further improved by means of the flexible charge-discharge ability of the energy storage device; moreover, the direct-current bus of the device may be connected to a direct-current distribution network with photovoltaic, wind or direct-current loads to improve the new energy consumption level of a system and flexibly change a power supply mode of the distribution network, as shown in FIG. 2. Preferably, to satisfy economic construction requirements, the grid direct-current flexible loop closing control device system model may be improved as follows: the grid direct-current flexible loop closing control device system model includes the series-parallel device, a series coupling device and an access switch, wherein the series coupling device is formed merely by the series coupling unit in the series-parallel device, thus reducing the manufacturing cost; similarly, the series-parallel device and the series coupling device are connected in series between the distribution lines requiring loop closing and the load, and direct-current buses of the series-parallel device and the series coupling device are connected to realize direct-current loop closing, as shown in FIG. 3.

Step 1.1, a model of the series coupling unit is constructed, wherein the specific implementation is shown in FIG. 5. The series coupling unit has three ports (two alternating-current ports and a direct-current port). Wherein, the two alternating-current ports are connected to a primary side of a series coupling transformer, a secondary side of the series coupling transformer is connected to an alternating side of a series-side inverter, and a direct-current terminal of the series-side inverter forms the direct-current port of the series coupling unit. The series-side inverter is formed by a three-phase full-bridge arm power unit, the power of which can flow bidirectionally, and a topology of the series-side inverter is configured as a two-level or cascaded multi-level structure. The series-side inverter acts by means of a PWM quick control switch to realize voltage stabilization, harmonic suppression and isolate voltage fluctuations of the direct-current bus.

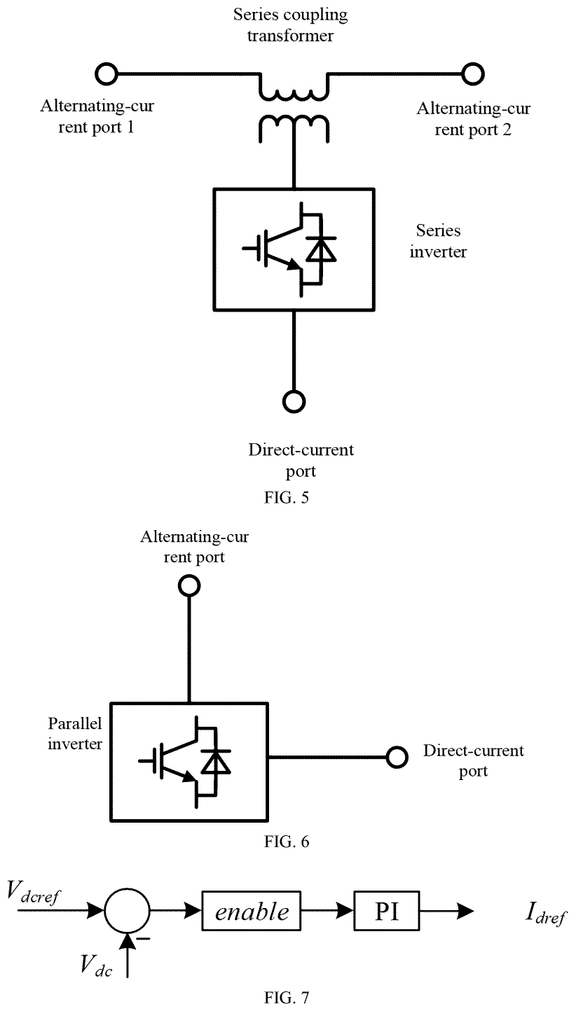

Step 1.2, a model of the parallel coupling unit is constructed, wherein the specific implementation is shown in FIG. 6. The parallel coupling unit has two ports and is formed by a parallel inverter. An output port on an alternating-current side of the inverter is an alternating-current port of the two-port parallel coupling unit, and an output port on a direct-current side of the parallel inverter forms a direct-current port of the parallel coupling unit. The parallel inverter is formed by a three-phase full-bridge arm power unit, the power of which can flow bidirectionally, and a topology of the inverter is configured as a two-level or cascaded multi-level structure. The parallel inverter can realize reactive compensation, harmonic suppression and voltage stabilization the direct-current bus by controlling power electronic devices in real time.

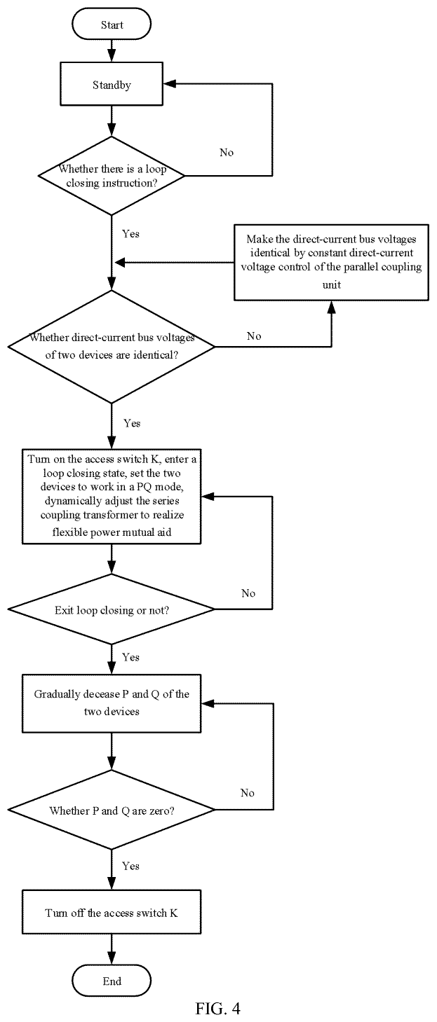

Step 2, control logic of the series and parallel coupling units for grid direct-current flexible loop closing is constructed, as shown in FIG. 4. The control logic is specifically as follows:

Step 2.1, power of two transmission lines requiring loop closing is monitored for a long time, and preparation is prepared in real time for loop closing. Before loop closing, a bus tie switch and an access are in an off state, and the two loop closing control devices work in a voltage control mode.

Step 2.2, after a loop closing instruction is received, whether direct-current bus voltages of the two loop closing control devices are identical is determined; if not, the direct-current bus voltages are controlled by means of a constant direct-current voltage control mode of the parallel coupling units; after the direct-current bus voltages are determined as identical, the direct-current access switch K is turned on, and a system enters a loop closing state; after loop closing, the amplitude and phase angle of an additional voltage of the series coupling transformer are set dynamically to realize flexible power mutual aid of the transformer regions subjected to loop closing.

Step 2.3, before the system exits loop closing, the two flexible loop closing control devices are set to work in a PQ control mode, the access switch K is turned off after P and Q of the two flexible loop closing control devices are gradually decreased to zero, such that a loop closing process is ended.

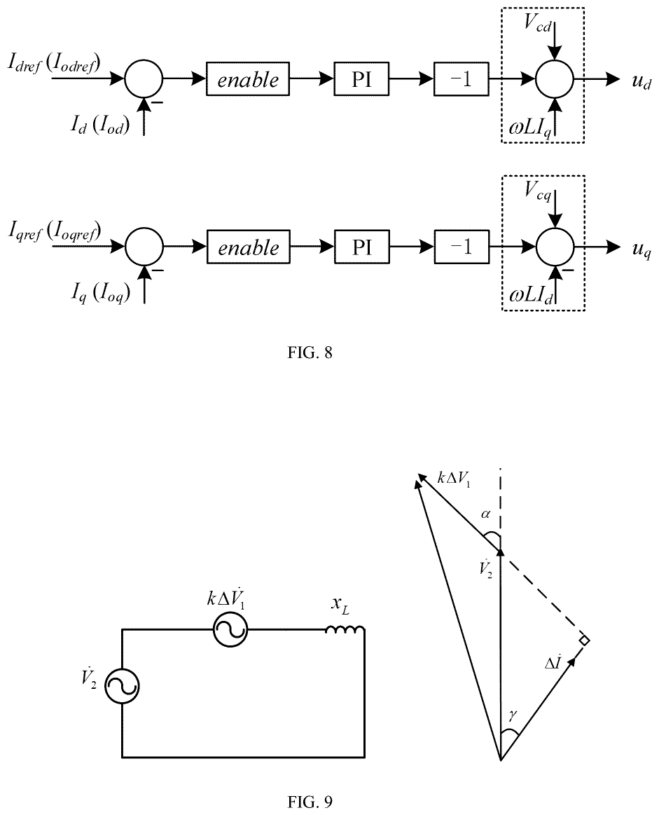

In Step 2.2, as shown in FIG. 7, the direct-current bus voltages are regulated by means of the constant direct-current voltage control mode of the parallel coupling units, wherein a direct-current side voltage of a parallel device is detected and compared with a given direct-current voltage, and an obtained voltage difference is input to a PI controller, and a PWM voltage control signal of a parallel transformer is output after current inner loop control (as shown in FIG. 8). Wherein, the PI controller or other controllers are used.

In Step 2.2, as shown in FIG. 9 which illustrates a vector diagram of the power mutual aid during flexible direct-current loop closing control, when power is transferred from line I with a supply voltage \dot{V}₁ to line II with a supply voltage \dot{V}₂, the parallel coupling unit in the transformer region of line I is adjusted to realize constant direct-current voltage control, and ΔV₁ is introduced to make the direct-current voltages of the two lines identical, at this moment, a variation of the direct-current bus voltage on line II is ΔV₁, and a variation of a corresponding compensating voltage of the series transformer on line II is k×Δ\dot{V}₁, where k is a no-load voltage ratio of the series coupling transformer on line II and can be adjusted according to the required compensating voltage. In the vector diagram, a phase angle of k×Δ\dot{V}₁ ahead of \dot{V}₂ is α; when α is any value within [0,2π], a line current increment generated by k×Δ\dot{V}₁ is Δİ=k×Δ\dot{V}₁/jx_{L} according to the superposition principle, and Δİ is lagged behind k×Δ\dot{V}₁ by 90° as shown by the vector diagram, so \dot{V}₂ is lagged behind Δİ by γ=90°−α; and the active current of ΔI_{P} is ΔI cos γ, and the reactive current of ΔI_{Q} is ΔI sin γ. An active power increment ΔP and a reactive power increment ΔQ of a power supply of line II are respectively:

$$Δ P = {V}_{2} Δ {I}_{P} = {V}_{2} Δ I cos γ = \frac{k \times Δ {V}_{1} {V}_{2}}{{x}_{L}} sin ( α )$$

$$Δ Q = {V}_{2} Δ {I}_{Q} = {V}_{2} Δ I sin γ = \frac{k \times Δ {V}_{1} {V}_{2}}{{x}_{L}} cos ( α )$$

A voltage V₂ and phase angle α of a grid-connection point remain unchanged, an equivalent reactance x_{L} remains unchanged, the no-load voltage ratio k of the series coupling transformer on line II remains unchanged, and adjustable active and reactive components are in a directly proportional and linear relation with ΔV₁.

It can be known, from the above analysis, that when power is transferred from line I to line II, the voltage difference Δ\dot{V}₁ of the compensating voltage of line I and the phase angle α of the corresponding compensating voltage of line II change within a certain range to regulate output power from line I to line II within a corresponding range, thus satisfying the technical requirement for flexible loop closing between buses of a power grid. Similarly, when power is transferred from line II to line I, the voltage difference Δ\dot{V}₂ of the compensating voltage of line II and the phase angle α of the corresponding compensating voltage of line I change within a certain range to regulate output power from line II to line I within a corresponding range.

Therefore, the output reactive power between two buses can be regulated by controlling the voltage between the two alternating-current ports of the series coupling units (the series compensating voltage of the series coupling transformer), thus satisfying the requirement for flexible loop closing control of the power grid.

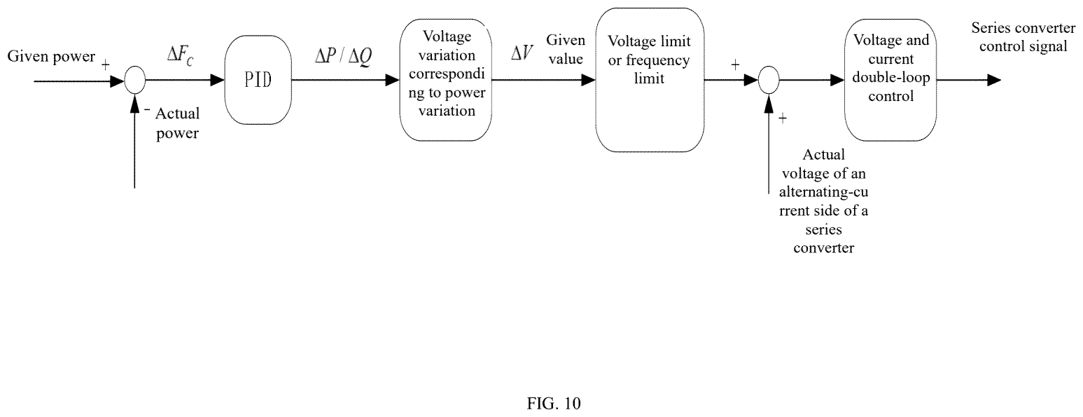

In Step 2.2, a block diagram of a control strategy for direct-current flexible loop closing is shown in FIG. 10. Power of two transformer regions requiring loop closing is measured and calculated, a given power value is obtained, and a difference between the given power and the measured power is subjected to PID control to obtain ΔP and ΔQ, a given value of the series compensating voltage ΔV in direct proportion with ΔP and ΔQ is obtained, a sum of the given value and the original alternating-current side voltage of the series coupling unit is input as a voltage reference value of the series coupling unit, closed-loop control is realized by means of a voltage outer loop and a current inner loop, and an output value is a voltage control signal of the series-side inverter.

Both the series coupling unit and the parallel coupling unit can adopt the vector control strategy, which mainly includes the following control modules: a PLL for detecting the phase of the alternating-current bus voltage, a PI controller (or other controllers according to a required control effect), a coordinate conversion module (abc/dq converter and dq/abc converter), a comparator, and the like. Multiple electric quantities, such as the direct-current bus voltage, the grid-side power, d-axis and q-axis components of the grid side voltage, and d-axis and q-axis components of the load-side current, can reach given values by means of vector control.

Closed-loop control of the series coupling unit is responsible for regulating the active power flow mutual-aid capacity of the system, and a voltage loop is used for controlling the amplitude and phase angle of an additional voltage of the series coupling transformer to realize active power flow control, which specifically includes the following steps:
(1) a voltage phase θₛ of a power supply bus connected to a series device is acquired by the PLL;
(2) an alternating-current voltage U of a power supply side of the series-side inverter is acquired, dq conversion is performed by means of the voltage phase of the alternating-current bus to obtain U_{d} and U_{q}, the alternating-current voltage is compared with a given voltage reference value, an obtained voltage difference is input to the PI controller to obtain an output current reference value, wherein the PI controller or other controllers are used; and
(3) the current reference value is subjected to current inner loop control to output a voltage control signal to a PWM series-side transformer, such that the amplitude and phase angle of the ΔV₁ or ΔV₂ of the series coupling transformer in line 2 are controlled.

During flexible control of the active power and reactive power transmitted between the two transmission lines, reactive power control is characterized in that the parallel coupling unit is used to realize reactive flow power control by means of closed-loop control, and specifically includes the following steps:
(1) a voltage phase θₛ of an alternating-current bus connected to the parallel device is acquired by the PLL; and
(2) a reactive current of an alternating-current system connected to the inverter of the parallel coupling unit is acquired, dq conversion is performed to obtain a current instruction, and a current difference between the reactive current and a given value is input to a PI controller to output a PWM voltage control signal to allow a parallel converter to output reactive power required by the system, such that reactive compensation is realized, wherein the PI controller or other controllers are used.

The invention is described in further detail above in conjunction with specific preferred embodiments, and the specific implementations of the invention should not be construed as being limited to the above description. Especially, other adjustments based on the structure of the device in the invention are essentially consistent with the invention, and various equivalent substitutions or obvious transformations with the same performance or purpose made by those ordinarily skilled in the art without creative labor should also fall within the protection scope of the invention.

What is claimed is:

1. A grid direct-current flexible loop closing control device, wherein the direct-current flexible loop closing control device is a series-parallel device, comprises two alternating-current ports, a direct-current port, and a three-port series coupling unit, a two-port parallel coupling unit, a bypass switch and a direct-current loop closing main controller;
wherein, two alternating-current ports of the three-port series coupling unit are connected in series to a line, and a direct-current port of the three-port series coupling unit is connected to a direct-current side of the two-port parallel coupling unit;
an alternating-current side of the two-port parallel coupling unit is connected in parallel to a distribution network line, and a direct-current port of the two-port parallel coupling unit is connected to a direct-current side of the three-port series coupling unit to form a direct-current output port of the series-parallel device;
the bypass switch is connected in parallel to the two alternating-current ports of the three-port series coupling unit, and the direct-current loop closing main controller is used for logic control of loop closing and receiving remote control.

2. The grid direct-current flexible loop closing control device according to claim 1, wherein the three-port series coupling unit comprises a series coupling transformer and a first power-bidirectionally controllable inverter, a primary side of the series coupling transformer is connected to an alternating-current line, and a secondary side of the series coupling transformer is connected to an alternating-current side of the first power-bidirectionally controllable inverter; and the two-port parallel coupling unit comprises a second power-bidirectionally controllable inverter, an alternating-current side of the second power-bidirectionally controllable inverter is connected in parallel to an alternating-current distribution network line, and a direct-current side of the second power-bidirectionally controllable inverter is connected to the direct-current side of the three-port series coupling unit, wherein a basic topology of a series-parallel loop closing control device is formed.

3. The grid direct-current flexible loop closing control device according to claim 1, wherein direct-current loop closing is implemented by connecting a flexible loop closing control device in series between a line in each transformer region requiring loop closing and a load, and then connecting the direct-current ports of the flexible loop closing control devices in the transformer regions requiring loop closing to transfer an active power flow between the transformer regions requiring loop closing by the direct-current ports.

4. The grid direct-current flexible loop closing control device according to claim 3, wherein to simplify a topology of the series-parallel loop closing control device to further reduce a manufacturing cost, the flexible loop closing control device is connected in series between the line in each transformer region requiring loop closing and the load, wherein the flexible loop closing control device in one transformer region only reserves the three-port series coupling unit, wherein the direct-current port of the three-port series coupling unit is connected to a direct-current bus of the series-parallel loop closing control device in the other transformer region to realize flexible loop closing of the two transformer regions.

5. The grid direct-current flexible loop closing control device according to claim 4, wherein to improve power supply flexibility and active power flow supportability to relieve a pressure in power supply capacity, an energy storage device with a DC/DC converter is connected to the direct-current bus of the series-parallel loop closing control device, and a control flexibility of power supply in the transformer regions is further improved by a flexible charge-discharge ability of the energy storage device; moreover, the topology is beneficial for improving a new energy accepting ability, realizing continuous and combined supply of new energy and stored energy, and achieving power supply to direct-current loads.

6. A grid direct-current flexible loop closing control method, comprising the following steps:
step 1, establishing a grid direct-current flexible loop closing control device system model, monitoring for a long time power of two transmission lines requiring loop closing, and making preparation in real time for loop closing;
step 2, before loop closing, setting a bus tie switch and an access switch to be in an off state and two loop closing control devices to be in a voltage control mode;
step 3, after a loop closing instruction is received, determining whether direct-current bus voltages of the two loop closing control devices are identical; if not, regulating the direct-current bus voltages by a constant direct-current voltage control mode of parallel coupling units; after the direct-current bus voltages of the two loop closing control devices are determined as identical, turning on the direct-current access switch K to allow a system to enter a loop closing state; after loop closing, dynamically adjusting an amplitude and phase of an additional voltage of a series coupling transformer to realize flexible power mutual aid of two transformer regions subjected to loop closing; and
step 4, before exiting loop closing, setting two flexible loop closing control devices to work in a PQ control mode, and turning off the access switch K after P and Q of the two flexible loop closing control devices are gradually decreased to zero, such that a direct-current flexible loop closing process is ended.

7. The grid direct-current flexible loop closing control method according to claim 6, wherein the grid direct-current flexible loop closing control device system model is established in step 1, wherein the grid direct-current flexible loop closing control device system model comprises two series-parallel devices and an access switch, each series-parallel device of the two series-parallel devices is connected in series between a transmission line and a load, and direct-current ports of the two flexible loop closing control devices are connected to realize direct-current loop closing; and each series-parallel device comprises a three-port series coupling unit, a two-port parallel coupling unit, a bypass switch and a direct-current loop closing main controller; two alternating-current ports of the three-port series coupling unit are connected in series to a line, and a direct-current port of the three-port series coupling unit is connected to a direct-current side of the two-port parallel coupling unit;
an alternating-current side of the two-port parallel coupling unit is connected in parallel to a distribution network line, and a direct-current port of the two-port parallel coupling unit is connected to a direct-current side of the three-port series coupling unit to form a direct-current output port of the series-parallel device; and
the bypass switch is connected in parallel to the two alternating-current ports of the three-port series coupling unit.

8. The grid direct-current flexible loop closing control method according to claim 7, wherein to improve power supply flexibility and active power flow supportability, an energy storage device is connected to a direct-current bus of the series-parallel device, and a control flexibility of power supply in the transformer regions is further improved by a flexible charge-discharge ability of the energy storage device; moreover, the direct-current bus of the series-parallel device is connected to a direct-current distribution network with photovoltaic, wind or direct-current loads to improve a new energy consumption level of the system and flexibly change a power supply mode of the direct-current distribution network.

9. The grid direct-current flexible loop closing control method according to claim 8, wherein to satisfy economic construction requirements, the grid direct-current flexible loop closing control device system model is improved as follows: the grid direct-current flexible loop closing control device system model comprises the series-parallel device, a series coupling device and an access switch; the series coupling device is formed merely by a series coupling module in the series-parallel device, thus reducing a manufacturing cost; similarly, the series-parallel device and the series coupling device are connected in series between distribution lines requiring loop closing and the load, and direct-current ports of the series-parallel device and the series coupling device are connected to realize direct-current loop closing.

10. The grid direct-current flexible loop closing control method according to claim 6, wherein in step 2, two loop closing control devices are set to be in the voltage control mode, wherein constant direct-current voltage control is performed by the two-port parallel coupling units of the two loop closing control devices, and direct-current closing is realized when the direct-current bus voltages of the loop closing control devices in the two transformer regions are identical.

11. The grid direct-current flexible loop closing control method according to claim 6, wherein in step 3, the direct-current bus voltages are regulated by the constant direct-current voltage control mode of the parallel coupling units, wherein a direct-current side voltage of a parallel device is detected and compared with a given direct-current voltage, and an obtained voltage difference is input to a first PI controller, and a PWM voltage control signal of a parallel transformer is output after current inner loop control; wherein, the first PI controller or other controllers are used.

12. The grid direct-current flexible loop closing control method according to claim 11, wherein in step 3, the amplitude and phase of the additional voltage of the series coupling transformer is dynamically adjusted to realize flexible power mutual aid of the two transformer regions subjected to loop closing, wherein an output voltage of the series coupling transformer in the transformer region where power needs to be fed is regulated, and an amplitude and phase angle of the output voltage are regulated within ranges to change active power and reactive power of the line to which power will be fed, thus realizing flexible regulation of active power and reactive power transmitted between the two transmission lines.

13. The grid direct-current flexible loop closing control method according to claim 12, wherein during flexible regulation of the active power and reactive power transmitted between the two transmission lines, active power control is characterized in that the amplitude and phase angle of the additional voltage of the series coupling transformer are controlled by a voltage loop of the three-port series coupling unit to realize active flow power control, and comprises the following steps:
(1) acquiring, by a first phase-locked loop (PLL), a voltage phase θₛ of a power supply bus connected to a series device;
(2) acquiring an alternating-current voltage U of a supply side of a series-side inverter, performing dq conversion by the voltage phase of the alternating-current bus to obtain U_{d} and U_{q}, comparing the alternating-current voltage with a given voltage reference value, inputting an obtained voltage difference into a second PI controller to obtain an output current reference value, wherein the second PI controller or other controllers are used; and
(3) subjecting the output current reference value to current inner loop control to output a voltage control signal to a PWM series-side transformer, such that the amplitude and phase angle of the additional voltage of the series coupling transformer are controlled.

14. The grid direct-current flexible loop closing control method according to claim 13, wherein during flexible regulation of the active power and reactive power transmitted between the two transmission lines, reactive power control is characterized in that the two-port parallel coupling unit is used to realize reactive flow power control by closed-loop control, and comprises the following steps:
(1) acquiring, by a second PLL, a voltage phase of the alternating-current bus connected to the parallel device; and
(2) acquiring a reactive current of an alternating-current system connected to an inverter of the two-port parallel coupling unit, performing dq conversion to obtain a current instruction, and inputting a current difference between the reactive current and a given value to a third PI controller to output a PWM voltage control signal to allow a parallel converter to output reactive power required by the alternating-current system, such that reactive compensation is realized, wherein the third PI controller or other controllers are used.

15. The grid direct-current flexible loop closing control device according to claim 2, wherein direct-current loop closing is implemented by connecting a flexible loop closing control device in series between a line in each transformer region requiring loop closing and a load, and then connecting the direct-current ports of the flexible loop closing control devices in the transformer regions requiring loop closing to transfer an active power flow between the transformer regions requiring loop closing by the direct-current ports.

16. The grid direct-current flexible loop closing control device according to claim 15, wherein to simplify a topology of the series-parallel loop closing control device to further reduce a manufacturing cost, the flexible loop closing control device is connected in series between the line in each transformer region requiring loop closing and the load, wherein the flexible loop closing control device in one transformer region only reserves the three-port series coupling unit, wherein the direct-current port of the three-port series coupling unit is connected to a direct-current bus of the series-parallel loop closing control device in the other transformer region to realize flexible loop closing of the two transformer regions.

17. The grid direct-current flexible loop closing control device according to claim 16, wherein to improve power supply flexibility and active power flow supportability to relieve a pressure in power supply capacity, an energy storage device with a DC/DC converter is connected to the direct-current bus of the series-parallel loop closing control device, and a control flexibility of power supply in the transformer regions is further improved by a flexible charge-discharge ability of the energy storage device; moreover, the topology is beneficial for improving a new energy accepting ability, realizing continuous and combined supply of new energy and stored energy, and achieving power supply to direct-current loads.

18. The grid direct-current flexible loop closing control method according to claim 7, wherein in step 2, two loop closing control devices are set to be in the voltage control mode, wherein constant direct-current voltage control is performed by the two-port parallel coupling units of the two loop closing control devices, and direct-current closing is realized when the direct-current bus voltages of the loop closing control devices in the two transformer regions are identical.

19. The grid direct-current flexible loop closing control method according to claim 8, wherein in step 2, two loop closing control devices are set to be in the voltage control mode, wherein constant direct-current voltage control is performed by the two-port parallel coupling units of the two loop closing control devices, and direct-current closing is realized when the direct-current bus voltages of the loop closing control devices in the two transformer regions are identical.

20. The grid direct-current flexible loop closing control method according to claim 9, wherein in step 2, two loop closing control devices are set to be in the voltage control mode, wherein constant direct-current voltage control is performed by the two-port parallel coupling units of the two loop closing control devices, and direct-current closing is realized when the direct-current bus voltages of the loop closing control devices in the two transformer regions are identical.

21. The grid direct-current flexible loop closing control method according to claim 7, wherein in step 3, the direct-current bus voltages are regulated by the constant direct-current voltage control mode of the parallel coupling units, wherein a direct-current side voltage of a parallel device is detected and compared with a given direct-current voltage, and an obtained voltage difference is input to a first PI controller, and a PWM voltage control signal of a parallel transformer is output after current inner loop control; wherein, the first PI controller or other controllers are used.

22. The grid direct-current flexible loop closing control method according to claim 21, wherein in step 3, the amplitude and phase of the additional voltage of the series coupling transformer is dynamically adjusted to realize flexible power mutual aid of the two transformer regions subjected to loop closing, wherein an output voltage of the series coupling transformer in the transformer region where power needs to be fed is regulated, and an amplitude and phase angle of the output voltage are regulated within ranges to change active power and reactive power of the line to which power will be fed, thus realizing flexible regulation of active power and reactive power transmitted between the two transmission lines.

23. The grid direct-current flexible loop closing control method according to claim 22, wherein during flexible regulation of the active power and reactive power transmitted between the two transmission lines, active power control is characterized in that the amplitude and phase angle of the additional voltage of the series coupling transformer are controlled by a voltage loop of the three-port series coupling unit to realize active flow power control, and comprises the following steps:
(1) acquiring, by a first phase-locked loop (PLL), a voltage phase θₛ of a power supply bus connected to a series device;
(2) acquiring an alternating-current voltage U of a supply side of a series-side inverter, performing dq conversion by the voltage phase of the alternating-current bus to obtain U_{d} and U_{q}, comparing the alternating-current voltage with a given voltage reference value, inputting an obtained voltage difference into a second PI controller to obtain an output current reference value, wherein the second PI controller or other controllers are used; and
(3) subjecting the output current reference value to current inner loop control to output a voltage control signal to a PWM series-side transformer, such that the amplitude and phase angle of the additional voltage of the series coupling transformer are controlled.

24. The grid direct-current flexible loop closing control method according to claim 23, wherein during flexible regulation of the active power and reactive power transmitted between the two transmission lines, reactive power control is characterized in that the two-port parallel coupling unit is used to realize reactive flow power control by closed-loop control, and comprises the following steps:
(1) acquiring, by a second PLL, a voltage phase of the alternating-current bus connected to the parallel device; and
(2) acquiring a reactive current of an alternating-current system connected to an inverter of the two-port parallel coupling unit, performing dq conversion to obtain a current instruction, and inputting a current difference between the reactive current and a given value to a third PI controller to output a PWM voltage control signal to allow a parallel converter to output reactive power required by the alternating-current system, such that reactive compensation is realized, wherein the third PI controller or other controllers are used.

25. The grid direct-current flexible loop closing control method according to claim 8, wherein in step 3, the direct-current bus voltages are regulated by the constant direct-current voltage control mode of the parallel coupling units, wherein a direct-current side voltage of a parallel device is detected and compared with a given direct-current voltage, and an obtained voltage difference is input to a first PI controller, and a PWM voltage control signal of a parallel transformer is output after current inner loop control; wherein, the first PI controller or other controllers are used.

26. The grid direct-current flexible loop closing control method according to claim 25, wherein in step 3, the amplitude and phase of the additional voltage of the series coupling transformer is dynamically adjusted to realize flexible power mutual aid of the two transformer regions subjected to loop closing, wherein an output voltage of the series coupling transformer in the transformer region where power needs to be fed is regulated, and an amplitude and phase angle of the output voltage are regulated within ranges to change active power and reactive power of the line to which power will be fed, thus realizing flexible regulation of active power and reactive power transmitted between the two transmission lines.

27. The grid direct-current flexible loop closing control method according to claim 26, wherein during flexible regulation of the active power and reactive power transmitted between the two transmission lines, active power control is characterized in that the amplitude and phase angle of the additional voltage of the series coupling transformer are controlled by a voltage loop of the three-port series coupling unit to realize active flow power control, and comprises the following steps:
(1) acquiring, by a first phase-locked loop (PLL), a voltage phase θₛ of a power supply bus connected to a series device;
(2) acquiring an alternating-current voltage U of a supply side of a series-side inverter, performing dq conversion by the voltage phase of the alternating-current bus to obtain U_{d} and U_{q}, comparing the alternating-current voltage with a given voltage reference value, inputting an obtained voltage difference into a second PI controller to obtain an output current reference value, wherein the second PI controller or other controllers are used; and
(3) subjecting the output current reference value to current inner loop control to output a voltage control signal to a PWM series-side transformer, such that the amplitude and phase angle of the additional voltage of the series coupling transformer are controlled.

28. The grid direct-current flexible loop closing control method according to claim 27, wherein during flexible regulation of the active power and reactive power transmitted between the two transmission lines, reactive power control is characterized in that the two-port parallel coupling unit is used to realize reactive flow power control by closed-loop control, and comprises the following steps:
(1) acquiring, by a second PLL, a voltage phase of the alternating-current bus connected to the parallel device; and
(2) acquiring a reactive current of an alternating-current system connected to an inverter of the two-port parallel coupling unit, performing dq conversion to obtain a current instruction, and inputting a current difference between the reactive current and a given value to a third PI controller to output a PWM voltage control signal to allow a parallel converter to output reactive power required by the alternating-current system, such that reactive compensation is realized, wherein the third PI controller or other controllers are used.

29. The grid direct-current flexible loop closing control method according to claim 9, wherein in step 3, the direct-current bus voltages are regulated by the constant direct-current voltage control mode of the parallel coupling units, wherein a direct-current side voltage of a parallel device is detected and compared with a given direct-current voltage, and an obtained voltage difference is input to a first PI controller, and a PWM voltage control signal of a parallel transformer is output after current inner loop control; wherein, the first PI controller or other controllers are used.

30. The grid direct-current flexible loop closing control method according to claim 29, wherein in step 3, the amplitude and phase of the additional voltage of the series coupling transformer is dynamically adjusted to realize flexible power mutual aid of the two transformer regions subjected to loop closing, wherein an output voltage of the series coupling transformer in the transformer region where power needs to be fed is regulated, and an amplitude and phase angle of the output voltage are regulated within ranges to change active power and reactive power of the line to which power will be fed, thus realizing flexible regulation of active power and reactive power transmitted between the two transmission lines.

31. The grid direct-current flexible loop closing control method according to claim 30, wherein during flexible regulation of the active power and reactive power transmitted between the two transmission lines, active power control is characterized in that the amplitude and phase angle of the additional voltage of the series coupling transformer are controlled by a voltage loop of the three-port series coupling unit to realize active flow power control, and comprises the following steps:
(1) acquiring, by a first phase-locked loop (PLL), a voltage phase θₛ of a power supply bus connected to a series device;
(2) acquiring an alternating-current voltage U of a supply side of a series-side inverter, performing dq conversion by the voltage phase of the alternating-current bus to obtain U_{d} and U_{q}, comparing the alternating-current voltage with a given voltage reference value, inputting an obtained voltage difference into a second PI controller to obtain an output current reference value, wherein the second PI controller or other controllers are used; and
(3) subjecting the output current reference value to current inner loop control to output a voltage control signal to a PWM series-side transformer, such that the amplitude and phase angle of the additional voltage of the series coupling transformer are controlled.

32. The grid direct-current flexible loop closing control method according to claim 31, wherein during flexible regulation of the active power and reactive power transmitted between the two transmission lines, reactive power control is characterized in that the two-port parallel coupling unit is used to realize reactive flow power control by closed-loop control, and comprises the following steps:
(1) acquiring, by a second PLL, a voltage phase of the alternating-current bus connected to the parallel device; and
(2) acquiring a reactive current of an alternating-current system connected to an inverter of the two-port parallel coupling unit, performing dq conversion to obtain a current instruction, and inputting a current difference between the reactive current and a given value to a third PI controller to output a PWM voltage control signal to allow a parallel converter to output reactive power required by the alternating-current system, such that reactive compensation is realized, wherein the third PI controller or other controllers are used.
